(19) United States
(12) Patent Application Publication
(10) Pub. No.: US 2011/0213847 A1
(43) Pub. Date: Sep. 1, 2011

(54) Information Service

(76) Inventor: Andrew Franklin Robinson, Takapuna (NZ)

(21) Appl. No.: 12/729,209

(22) Filed: Mar. 22, 2010

Related U.S. Application Data
(63) Continuation-in-part of application No. 11/514,142, filed on Sep. 1, 2006, now Pat. No. 7,685,110.

(30) Foreign Application Priority Data
Sep. 2, 2005 (NZ) 542178

(51) Int. Cl. G06F 15/16

(52) U.S. Cl. 709/206

(57) ABSTRACT

An information service includes a network and material on the network provided by an entity. The network provides or is linked to, a request for information elements for submission of a request by the submitter to the entity. Elements are provided to optionally provide an inducement to likely submitters or selected subgroup or subgroups of likely submitters to submit a query. Communication between submitters and the entity may be by email, online forms, or instant messaging using typewritten or audio-visual communications.

This application is a Continuation in Part application of U.S. application Ser. No. 11/514,142, filed Sep. 1, 2006 which claims priority to New Zealand patent application 542178 filed on Sep. 2, 2005, both of which are incorporated herein in their entirety by reference.

The invention disclosed and described relates to an information service. More particularly the invention relates to an information service which has been devised particularly, though not necessarily solely, for providing information over the internet, a wide area network, or a local area network.

### FIELD OF THE INVENTION

Throughout the description and claims of this specification the word “comprise” and variations of that word, such as “comprises” and “comprising”, are not intended to exclude other additives, components, integers or steps.

### BACKGROUND OF THE INVENTION

This invention relates to an information service and has been devised particularly, though not necessarily solely, for providing information over the internet or a local area network.

Online publishers of information such as bloggers and web page publishers can post information and receive comments on their information from viewers to their blog or web page.

The online publishers of information can also post an email address or a form which allows the online user to contact the online publisher of information directly.

However, there remains a need for a system or service that would allow the online publisher of information to sell their expertise and also to provide an inducement to online users to seek information from the online publisher of information. Such a system should not only allow for written responses regarding the publisher's expertise, but should also allow for text and audio responses in real time, via online instant messenger between publisher to users, or real time video conversations, between users and publishers of information, whereby consecutive questions and answers may be asked and answered for a fuller understanding of the subject matter being provided by the publisher to the inquiring user.

It is therefore an object of the present invention to provide an information service which will go at least someway towards meeting the foregoing requirement in a simple yet effective manner or which will at least provide the public with a useful choice.

It is a further object of the present invention to not only provide written responses subsequent to inquiries from submitting users, but to also provide for real time two-way communications via instant messenger or similar means or by online audio-visual communications, such as a web-cam or display, between information providers and users.

### SUMMARY OF THE INVENTION

Accordingly, a first aspect the invention consists of an information service comprising a network, material on the network provided by an entity, the network providing, or being linked to, a request for information means, for submission of a request by a submitter to the entity, and means to optionally provide an inducement to likely submitters or selected subgroup or subgroups of likely submitters to submit a query. In another mode of the invention, real time communications may be initiated between the submitter and someone of expertise at the entity to allow for instant messaging between the parties, or exchange of sequential inquiries and responses via online audio-video.

Preferably the inducement comprises a reward.

Preferably the inducement comprises a monetary reward.

Alternatively, the inducement comprises a reward having a non monetary value.

Preferably the service further provides means to enable the entity to charge a fee for response to a request for information.

Preferably the service further provides means to enable the entity to charge a time-based fee for real time online responses to a real time request for information via instant messaging or networked audio-video communications.

Preferably the request for information means is provided by a clearing house or service provider.

Preferably the entity can provide further inducements to the submitter of a request for information.

Preferably the network is the internet or a local area network.

Preferably the system further includes means to enable the submitter to increase the reward to the entity.

In a further aspect the invention consists in a method of providing information comprising the steps of providing material on a network, providing a request for information means to allow submission of a request by a submitter, and means to optionally provide an inducement to likely submitters or selected subgroup or subgroups of likely submitters to submit a query.

Preferably the inducement comprises a reward.

Preferably the inducement comprises a monetary reward.

Alternatively, the inducement comprises a reward having a non monetary value.

Preferably the service further provides means to enable the entity to charge a fee for response to a request for information.

Preferably the service further provides this means to enable the entity to charge a fee for response to a request for information with the option of charging by the time duration of an ongoing communication if elected instead of a one time response.

Preferably the request for information means is provided by a clearing house or service provider.

Preferably the method further includes means to allow further inducements to be provided to the submitter of a request for information.

Preferably the network is the internet or a local area network.

Preferably the network provides real time instant messaging capabilities and/or real time audio-visual communication capabilities to allow time-based submissions and responses.

Preferably the method further includes means to enable the submitter to increase the reward to the entity.

To those skilled in the art to which the invention relates, many changes in construction and widely differing embodiments and applications of the invention will suggest themselves without departing from the scope of the invention as defined in the appended claims. The disclosures and the description herein are purely illustrative and are not intended to be in any sense limiting.

One preferred form of the invention will now be described with reference to the accompanying drawings in which,

### BRIEF DESCRIPTION OF THE DRAWINGS

FIGS. 1-3 are flow charts indicating key elements of the invention.

FIG. 4 is a representation of a pop-up box or page that can be used to solicit queries by using a preferred from of the invention.

FIG. 5 is a log-on box usable in a preferred form of the invention by an online information provider.

FIG. 6 indicates a possible registration form for use by an online information provider in the preferred form of the invention.

FIG. 7 shows a configuration chart usable in a preferred form of the invention to allow an on-line publisher of information to join the service, and to input fees for either per query written communicated individual responses, or timed online chat or audio-video responses.

FIG. 8 indicates a code form usable to provide the service on, for example, a web page.

FIG. 9 shows diagrammatical information that an online publisher of information may provide to the service provider to enable users to be ranked as to their value to the online information provider, and to give funds, queries, or chat minutes to a domain, or social network, if desired,

FIG. 10 shows an additional form useful in allowing users to be ranked,

FIG. 11 shows a representation of an online publisher of information in possible email domain rankings.

FIG. 12 indicates a further list of users to view or add to existing registered users.

FIG. 13 is a page allowing further information to be provided to the service.

FIG. 14 is a page indicating inducements that can be given to people likely to submit requests.

FIG. 15 shows a log-on form for a potential query submitter to use the service.

FIG. 16 confirms that a query is to be submitted.

FIG. 17 is a form enabling a response to be made and to provide free queries or free chat minutes to a designated party.

### DETAILED DESCRIPTION OF THE INVENTION

One preferred form of the invention will now be described with reference to the accompanying drawings.

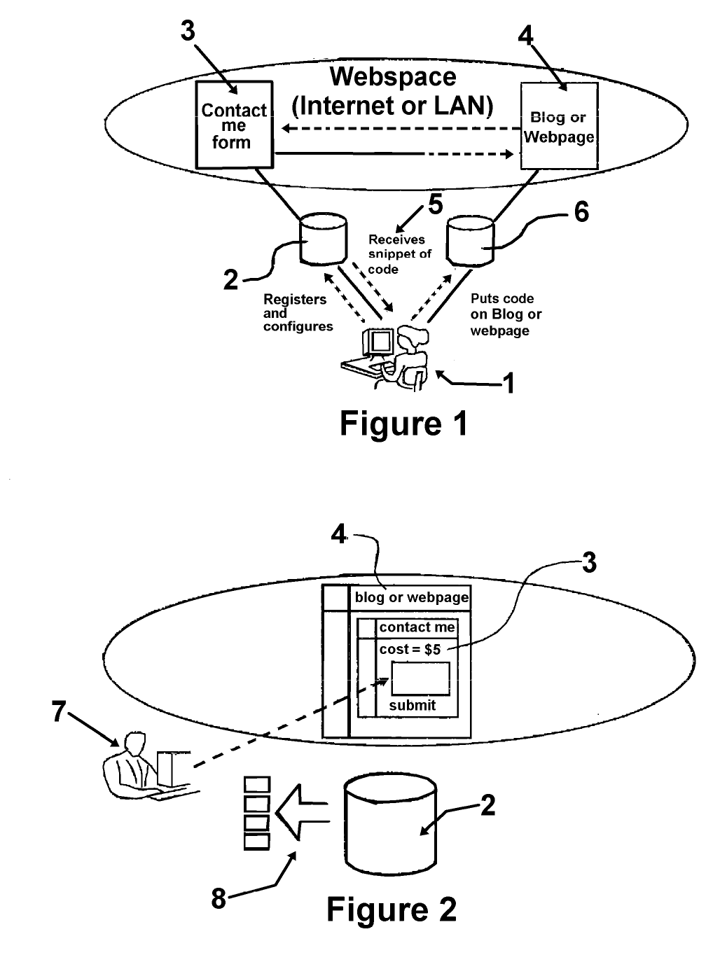

Referring to FIGS. 1, 2 and 3 an online publisher of information 1 registers and configures with a service provider 2.

Through the service provider 1 a “contact me” form 3 is provided on a searchable database which is preferably a webspace such as the internet or a local area network. The contact form may be provided, for example, on a blog or a web page 4. The online information provider 1 may receive snippets of code at 5 and also places a code provided, for example, by the service provider 2 on to the blog or web page, for example, through server 6. The code is received when the online publisher of information has registered and configured their page. When the code is entered in, for example, the blog or web page either the “contact me” form 3 may be provided on the blog or web page or there may be a link from the blog or web page to the “contact me” form.

FIG. 2 shows the “contact me” form 3, as for example, a pop-up on the blog or web page 4. A user or potential request submitter 7 may visit the blog or web site page 4 and using the “contact me” form 3 may submit a query to the online publisher of information 1. The system is optionally able to provide a reward to the submitter of the request and this will be described further later but at least the service provider 2 knows the value of any reward which may be money, or a non monetary reward such as points, virtual currency, or free queries or free chat minutes for instant messaging, or any other device having a value. The user 7 either has enough value to submit a query indicated in FIG. 2 at a cost of say $5, or must buy more, for example, through a credit card payment facility 8 or using prior awarded or earned free chat minutes, or prior earned or awarded free queries.

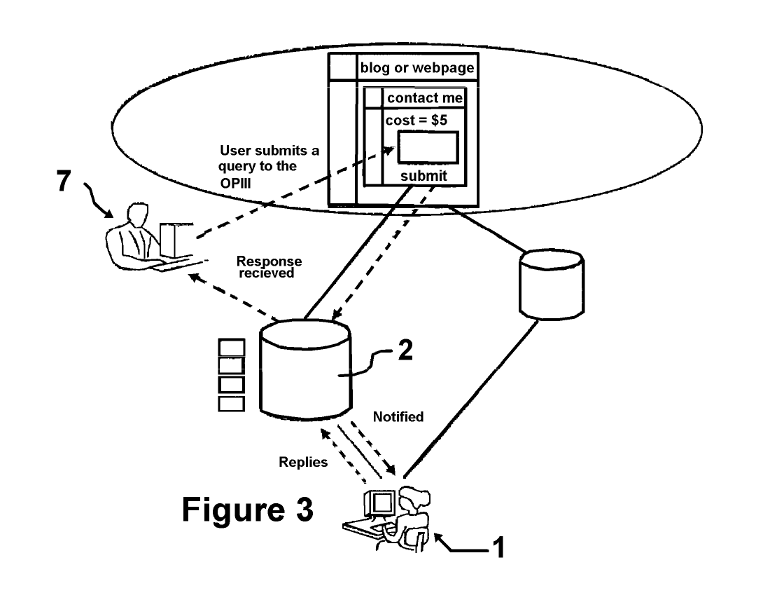

The user 7 then submits the query as indicated in FIG. 3 and the online publisher of information 1, can then respond to query from the submitter 7, either through the server 2 or directly, for example, by email, and if it is desired can offer an inducement towards submitting further queries by providing a reward to the submitter 7.

In another preferred mode of the invention, the query and response may also be by online instant messenger using type-based “chat” programs, or the query and response can be by online audio-video means, such as a web-cam or display, using an online link between the parties. Either of these real time communication modes is billed and remunerated by the minute for the time taken during the ongoing exchange. Of course, because the queries and responses are in real time and ongoing and allow for sequential queries by a submitter, followed by sequential responses by the publisher to the submitter, much more detail and personalized information may be provided the submitter.

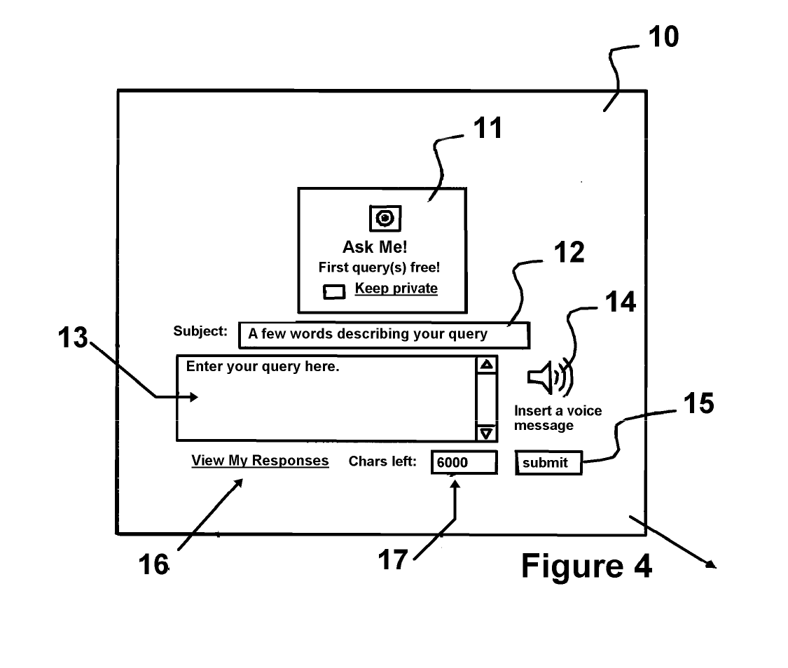

FIG. 4 shows a pop-up box 10 or alternatively the material can be provided on another page which enables a potential submitter of a query to contact the online information provider 1. The form 10 may have an information panel 11, a space for a subject at 12, and a space to enter the query at 13. An indication to allow a voice message can be provided at 14 along with a typical submit button 15.

A message allowing responses to be viewed can be provided at 16 and indication of available space at 17. This process will be described further hereinafter.

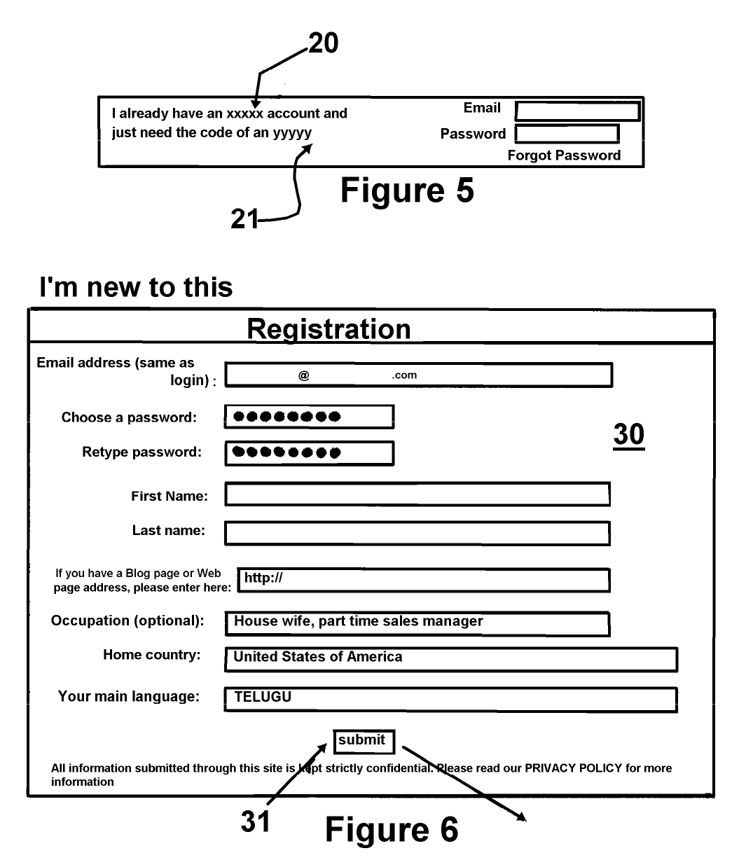

Turning now to FIG. 5, this allows an online information provider to access their account with the service provider indicated at 20 and indicate that they need a further code 21 for the system provided by the invention. Once the email and password are entered the online information provider is taken to form 30 indicated in FIG. 6 which seeks typical information such as email address, password, name information, optionally occupation, home country, and language.

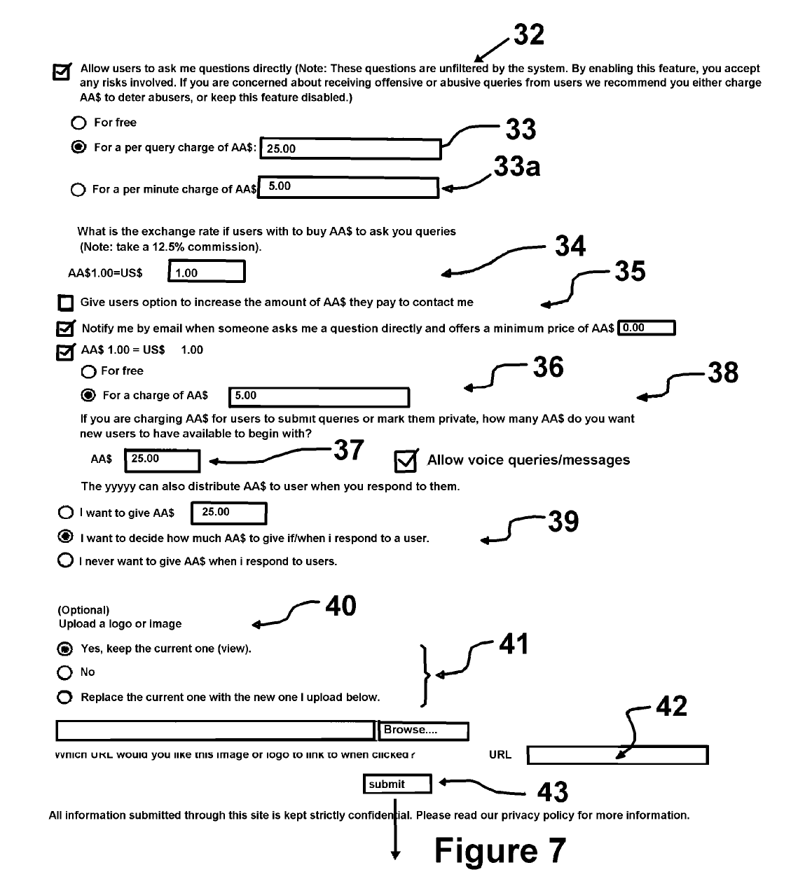

Once the submit button 31 is pressed the online information provider is taken to form 32 indicated in FIG. 7, which allows the information provider to configure their service. Thus at 33 the option is provided to charge a fee for the response to a query (including a free option as indicated). At 33a, the option is also provided to allow charges by the minute for real time instant messaging and audio-video responses which are charged by the minute. At 34 there is an opportunity for the online information provider to indicate an exchange rate between the value of the inducement offered and for example, a currency such as United States dollars. At 35 an opportunity is provided which will allow a query submitter to increase their payment if desired, for example, to increase their priority in terms of receiving a response to their query. Panel 36 allows a privacy option, for example at an extra fee.

Panel 37 allows an initial inducement to submit queries to be provided to a user and 38 activates the voice query option. 39 indicates options in relation to the provision of an inducement to the user such as providing a reward at a standard amount, providing a reward selected by the online information provider, or never providing an inducement.

Optional features such as an uploading of a logo or image is provided at 40 or to change the image at 41.

The URL to which clicking the logo or image will lead can be entered at 42.

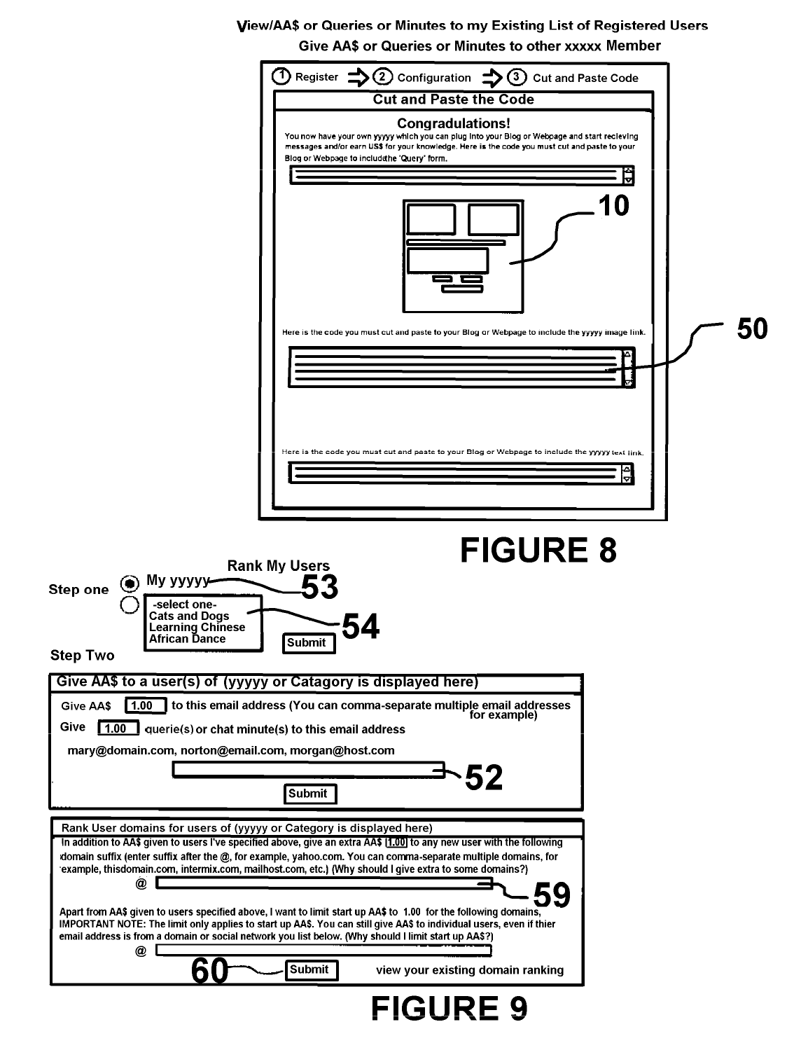

Once the submit button at 43 is pressed the online information provider is taken to the material in FIGS. 8 and 9.

FIG. 8 is representative of a code provided by the surface provider 2 as at 50 and the panels in FIG. 9 allow further options.

The code at 50 is cut and pasted on to the blog or web site for example, of the online information provider and this will have the effect of causing the form of FIG. 4 to be displayed on the blog or website.

FIG. 9 commences the procedure for ranking users, that is to say, request submitters. Panel 51 allows an inducement in the form of funds, or free chat minutes on the instant messenger, or free quires, to be provided to a designated email address entered at 52 and requests the questions be directed to the online service providers now set up page indicated as “yyyyy” at 53. If the online information provider has selected categories, these can then be displayed at 54.

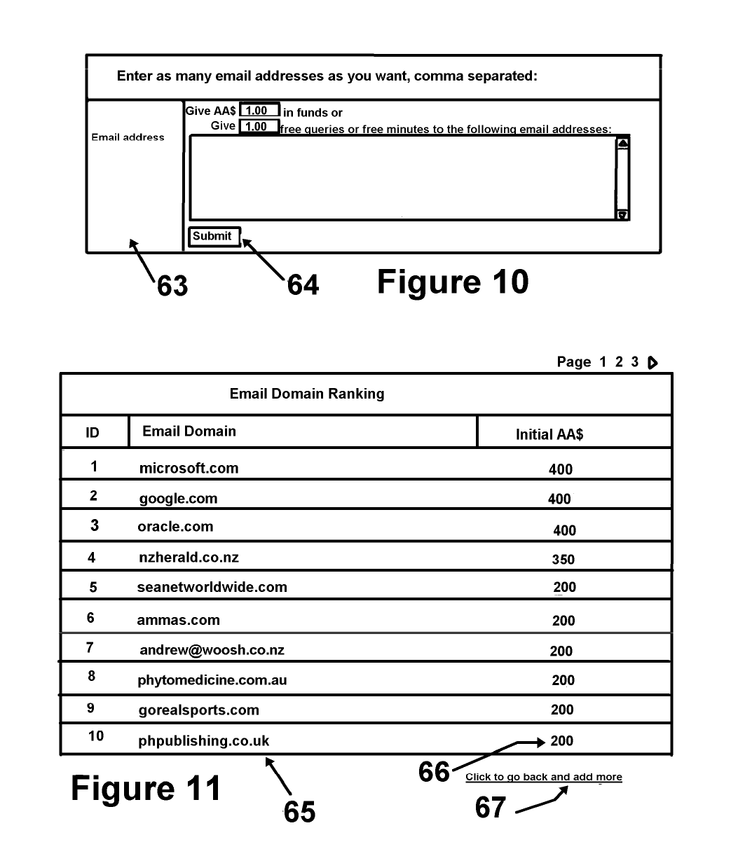

Panel 57 allows uploading of multiple email addresses and panel 58 allows an inducement to be provided, for example, to users having a particular domain suffix or social network identification, entered at 59. When submit button 60 is pressed the online information provider is taken to the panel 63 indicated in FIG. 10, which also allows multiple email addresses to be uploaded and submitted by pressing submit button 64. As shown, remuneration in funds or by free chat minutes or free quires may be communicated to the chosen email addresses.

A user can click on a panel to view existing domain rankings to bring up the panel 65 shown in FIG. 11 where various email domains are indicated by way of example only.

Initial reward values are indicated at 66.

Clicking the wording at 67 takes the user back to the “rank my users” page indicated in FIGS. 9 and 10.

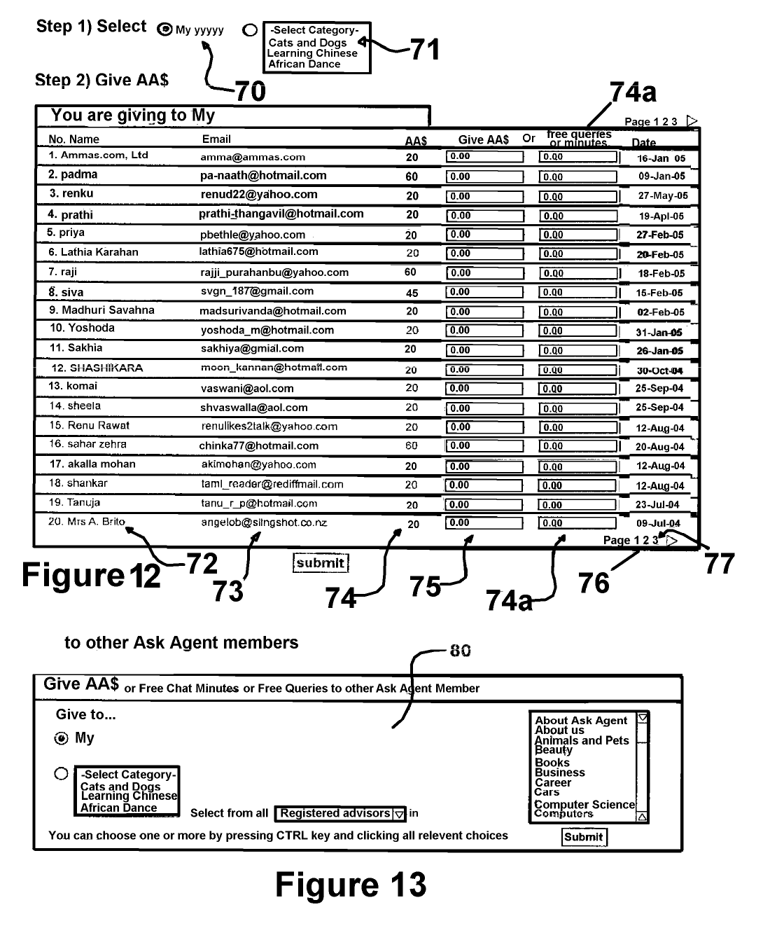

Panel 70 in FIG. 12 allows the online information provider to view or add to their existing list of registered users and again allows category selection at 71 if desired.

The construction at FIG. 12 allows further users to be entered at 72 with their email address at 73. Reward values standing to those that users credit indicated at 74 and in amounts to be given by way of inducement when those submitters submit a query as indicated at 75. The reward values as shown may be one or a combination of credits 74, or chat minutes or free queries as shown in the second column 74a. The date the particular user first entered the online information providers service page may be shown at 76. Multiple pages are indicated at 77.

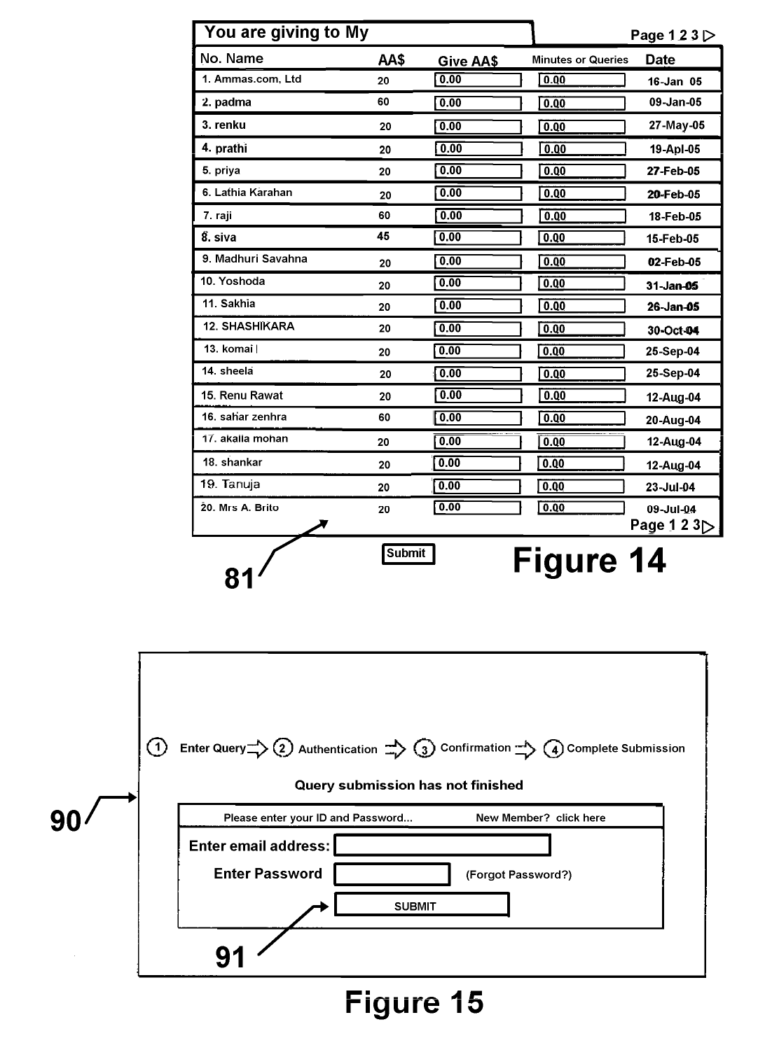

If the online information provider selects to give rewards to other members of their system this material can be entered in panels 80 on FIG. 13 or as indicated in FIG. 14 in the form of points, free queries or free online chat or audio-video minutes.

Panel 90 in FIG. 15 is a panel usable as part of the query submitting system being the initial page that must first be entered.

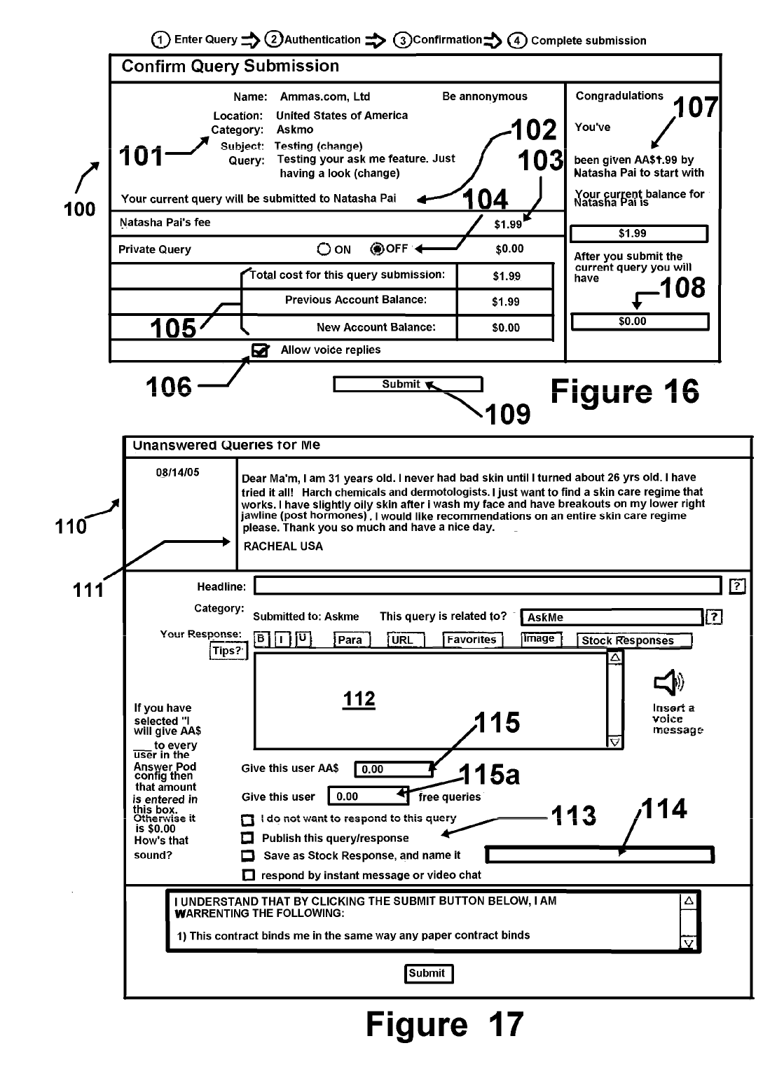

Pressing the submit button 91 takes the persons submitting the query to panel 100 shown in FIG. 16.

Options are indicated at 101 along with an indication to who the query is submitted to at 102. This is selected by the submitter. The online information provider's fee is indicated at 103 and the option for privacy indicated at 104.

Panels 105 show the state of the submitters account and also includes an option for voice reply at 106. Any initial inducement to submit a query is indicated at 107 and the account total after the query has been submitted is indicated at 108.

Once the submit button 109 is pressed the query is submitted.

FIG. 17 indicates the reply panel or page 110 with the query indicated at 111 and the response at 112.

The responder's options are indicated at 113 such as not wishing to respond to the query, publishing the query and response, or saving as a stock response under a name indicated at 114, or by an online chat response using an instant messenger program or audio-video link.

The amount of any reward or inducement to the query submitter is entered at 115 or in minutes of chat or individual free queries 115a.

Thus, it can be seen that an information service or a method of providing information is provided which has the advantage that the online information provider can be accessed through a blog or web page in a web space such as the internet or local area network. The system is of particular advantage as it allows an inducement to be offered to likely submitters, groups of submitters, or sub-groups of submitters to make a submission. The system also provides a plurality of means for response and communication between the submitter and publisher including written responses, as well as real time chat responses using instant messaging or an audio-video program link between the submitter and source of the response.

This acts as a type of discount and can be offered to selected persons. The option to allow the submitter to increase their fee to elevate their priority is also desirable.

While all of the fundamental characteristics and features of the disclosed method and apparatus providing a network service for communication between publishers of information and submitters, with reference to particular embodiments thereof which have been shown and described, a latitude of modification, various changes and substitutions are intended in the foregoing disclosure and it will be apparent that in some instance, some features of the invention will be employed without a corresponding use of other features, or steps may be rearranged for operations, without departing from the scope of the invention as set forth.

It should be understood that such substitutions, modifications, and variations may be made by those skilled in the art without departing from the spirit or scope of the invention. Consequently, all such modifications and variations are included within the scope of the invention as defined herein.

What is claimed is:

1. An information service comprising:
a network comprising at least one computer server;
material on the network provided by an entity;
a request for information means, for submission of a request for information by a submitter to the entity, the request for information means being provided by the network or being linked to the network, the request for information means being computer based;
means by which the entity passes the request for information to an information provider;
means for the information provider to provide an inducement selected by the information provider to the submitter, to likely submitters, and to selected subgroup or subgroups of likely submitters to submit the request for information; and
means for the entity to receive submitted requests for information; and
means to provide said information to said submitter.

2. An information service as claimed in claim 1 wherein the inducement comprises one of, a monetary award or a non monetary reward.

3. An information service as claimed in claim 1 wherein said means to provide said information to said submitter is an online instant messenger program communicating said information to said submitter.

4. An information service as claimed in claim 2 wherein said means to provide said information to said submitter is an online instant messenger program communicating said information to said submitter.

5. An information service as claimed in claim 1 wherein said means for submission of a request for information by a submitter to the entity includes communication of at least part of said request for information using a networked instant messaging program.

6. An information service as claimed in claim 2 wherein said means for submission of a request for information by a submitter to the entity includes communication of at least part of said request for information using a networked instant messaging program.

7. An information service as claimed in claim 3 wherein said means for submission of a request for information by a submitter to the entity includes communication of at least part of said request for information using a networked instant messaging program.

8. An information service as claimed in claim 4 wherein said means for submission of a request for information by a submitter to the entity includes communication of at least part of said request for information using a networked instant messaging program.

9. A method of providing information comprising the steps of:
an entity providing material on a network via a computer server;
providing an instant messaging request for information means, to allow submission of a request by a submitter, to the entity, using sequential instant messages, the request for information means being computer based;
the entity passing the request for information to an information provider and the information provided providing an inducement selected by the information provider to likely submitters or selected subgroup or subgroups of likely submitters to submit requests for information;
the entity receiving at least a portion of the request for information from the submitter via said instant messaging request; and
the entity communicating at least a portion of a response from said information provider, to said submitter, via said instant messaging program.

10. The method of claim 9 additionally comprising:
providing said instant messaging program adapted to accept and communicate typewritten text to and from said submitter.

11. The method of claim 9 additionally comprising:
providing said instant messaging program adapted to use video and audio to and from said submitter.

12. A method as claimed in claim 9 additionally comprising:
providing said inducement in the form of a reward.

13. A method as claimed in claim 9 additionally comprising:
providing said reward with a monetary value.

14. A method as claimed in claim 9 wherein the inducement comprises a reward having a non monetary value.

15. A method as claimed in claim 9 wherein the request for information means is provided by a clearing house or service provider.

14. A method as claimed in claim 9 wherein the method further includes means to allow further inducements by the information provider to be provided to the submitter of a request for information.

15. A method as claimed in claim 9 comprising the further step of the entity increasing the inducement to the submitter or submitters.

16. An information service of claim 9, wherein the inducement is free time for employment of said instant messaging program.

17. The method of claim 9, wherein the inducement is a reduction in the fee charged for the response to the request for information.
